(19) United States
(12) Patent Application Publication
(10) Pub. No.: US 2004/0165106 A1
(43) Pub. Date: Aug. 26, 2004

(54) Digital camera

(75) Inventor: Yoshio Nakagawa, Toyohashi-Shi (JP)

Correspondence Address: MCDERMOTT, WILL & EMERY, 600 13th Street, N.W., WASHINGTON, DC, 20005-3096, US

(73) Assignee: Minolta Co., Ltd.

(21) Appl. No.: 10/426,791

(22) Filed: May 1, 2003

(30) Foreign Application Priority Data
Feb. 21, 2003 (JP) 2003-044333 PAT.

(51) Int. Cl. H04N 5/222; H04N 5/225

(52) U.S. Cl. 348/373; 348/333.06; 348/220.1

(57) ABSTRACT

A digital camera which can be handled by a user with a high operability, when the user takes a still image of an object and when the user takes a motion image thereof. The digital camera includes: an optical system, a picture-taking direction of which can be changed; an operation part for switching over between a first mode and a second mode; and an interlocking part for changing the picture-taking direction of an optical system, in which the interlocking part is interlocked with the switchover of the operation part between the first mode and the second mode.

This application is based upon application No. 2003-44333 filed in Japan, the contents of which are hereby incorporated by reference.

### BACKGROUND OF THE INVENTION

1. Field of the invention

The present invention generally relates to a digital camera, and particularly relates to the digital camera which is possible to change its direction in which its camera body is orientated with respect to an object to be photographed in order to take a still/moving image of the object.

2. Description of the Related Art

Conventionally, there have been provided a digital cameras which can take not only a still image, but also a moving image (or moving picture or motion picture). The switchover, of the digital camera, between a mode for taking the still image and a mode for taking the moving image, is performed by changeover of the setup dial or of the changeover switch. In most of the digital cameras, the direction in which its camera body is orientated with respect to an object to be photographed in order to take an image thereof, when the image is a moving image, is the same as the direction in which its camera body is orientated with respect to an object to be photographed in order to take an image thereof, when the image is a still image, and its user takes a photograph of the object with his/her holding the camera body by the hand in both of the situations.

Meanwhile, there has been provided a camera which can change its direction in which the image of an object is captured or taken. For example, there has been provided a camera that its angle for photographing an object can be changed, by shifting the angle of the liquid crystal viewfinder (display part) and by shifting the photographing unit, as disclosed in Japanese Laid-Open Patent Publication No. 10-285440. Also, for example, there has been provided a camera that lenses and a light emitter of a flash device rotate up and down integrally so as to facilitate the capture of the object image at a low angle and at a high angle, respectively, and that the self-image is possible to be taken, as disclosed in U.S. Pat. No. 6,445,417 B1.

Meanwhile, there has been proposed a portable terminal (PDA or Personal Digital Assistant) having a camera that its function can be switched over by changing the angle between its monitor and the body of the portable terminal. Namely, the portable terminal can be used as a camera when the monitor is opened; on the other hand, it can be used as a portable terminal when the monitor is closed. According to the mechanism of the portable terminal, its flipping part, as a monitor part, pivots with respect to the body; and any particular function, or assigned function, is selectively performed, in accordance with the angle between the flipping part and the body, namely in accordance with the positional relation therebetween. The portable terminal has a pair of image taking parts: one is mounted on the rotation axis part on a side of the body, and the other is mounted on the flipping part. When the orientation of one of the pair of the image taking parts is opposite to the orientation of the other thereof with the body part and the flipping part opening to each other, the portable terminal performs a function as a digital camera, as disclosed in United States Laid-Open Patent Publication No. US 2001/0004269 A1.

Meanwhile, there has been provided a digital camera (or digital still camera) for taking a still image of an object, which has the function to take a moving image of the object. The initial model of the digital camera could take a moving image over a short time. However, with development of technology, the capacity of recording medium becomes larger, the performance of the battery becomes higher, the ability of the camera to save electricity becomes higher, and the compression rate of data, such as in the form of MPEG 4, etc., becomes higher. Therefore, the recent model of the digital camera can take the moving image over a long time (several hours, for example).

However, when the user wants to take a moving image with the recent digital still camera for such a long time, he/she must keep the camera with both of the hands, as in the same way as when he/she takes any still image with the camera, in order to better hold the camera body. Therefore, while the user takes the moving image with the camera during a longer time, the user may feel the hand(s) and/or arm(s) be tired or fatigued so that the operability of the camera decreases.

On the other hand, there has been provided a camera that the direction that a taking lens faces, that is, direction of taking the image, relative to a camera body, can be changed. However, such a camera is not constructed so as to be suitable for taking any moving image, and the position(s) of the operation button(s) used for taking the moving image is/are the same as those used for taking the still image. Therefore, with the arrangement, it is inconvenient for the user to handle and operate such a camera.

### SUMMARY OF THE INVENTION

Therefore, it is an object of the present invention to provide a digital camera with an excellent operability with which the user can handle the camera easily and conveniently, upon taking any still image and moving image.

In accomplishing this and other objects of the present invention, according to one aspect thereof, there is provided a digital camera comprising: an optical system which can change a direction of taking an image of an object with respect to a body of the digital camera; an operation part for switching a mode between a first mode and a second mode; and a mechanism for making the optical system change the direction of taking the image thereof, in interlock with a switchover of the mode therebetween by the operation part.

According to the mechanism, the direction of taking the image by the optical system is changed, in interlock with the switchover of the mode between the first mode and the second mode by the operation part. By switching the mode thereby, the direction, suitable for the selected mode, of taking the image of the object by the optical system is automatically set. Therefore, with the mechanism, a digital camera with an excellent operability with which the user can handle the camera easily and conveniently in the plurality of modes, or upon taking any still and moving image of an object, is realized.

In accomplishing the above objects of the present invention, according to another aspect thereof, there is provided a digital camera comprising: an optical system which can change a direction of taking an image of an object with respect to a body of the digital camera; and a detector for detecting a change of the direction of taking the image thereof, wherein the digital camera has a selective mode including a first mode and a second mode, in which one of the first mode and the second mode is selected on a basis of the change of the direction thereof detected by the detector.

According to the mechanism, one of the first mode and the second mode is automatically selected on the basis of the change of the direction thereof detected by the detector. Therefore, with the mechanism, a digital camera with an excellent operability with which the user can handle the camera easily and conveniently in the plurality of modes, or upon taking any still and moving image of an object, is realized.

In accomplishing the above objects of the present invention, according to still another aspect thereof, there is provided a digital camera comprising: an optical system, a direction of taking an image of an object by the optical system being able to be changed about an axis which is parallel to a direction in which a longer side of an upper surface of a housing of the digital camera extends, in which the digital camera has a first image taking mode and a second image taking mode; a first operation member which functions when the digital camera is in the first image taking mode; a second operation member which functions when the digital camera is in the second image taking mode; and a controller for switching an ON/OFF of function of the first operation member and the second operation member, on a basis of the direction of taking the image of the object.

According to the mechanism, the controller automatically switches an ON/OFF of function of the first operation member and the second operation member, on the basis of the direction of taking the image of the object. Therefore, with the mechanism, a digital camera with an excellent operability with which the user can handle the camera easily and conveniently in the plurality of modes, or upon taking any still and moving image of an object, is realized.

### BRIEF DESCRIPTION OF THE DRAWINGS

This and other objects and features of the present invention will become clear from the following description taken in conjunction with the preferred embodiments thereof with reference to the accompanying drawings.

FIG. 1 is a perspective view of a digital camera, shown from its front side, according to a first embodiment of the present invention, in which the digital camera is in a state upon taking a still image.

FIG. 2 is a perspective view of the digital camera, shown from its rear side, of FIG. 1, in which the digital camera is in the state upon taking the still image.

FIG. 3 is a perspective view of the digital camera, shown from its front side, of FIG. 1, in which the digital camera is in a state upon taking a moving image.

FIG. 4 is a perspective view of the digital camera, shown from its rear side, of FIG. 1, in which the digital camera is in the state upon taking the moving image.

FIG. 5 is a perspective view of a digital camera, shown from its front side, according to a second embodiment of the present invention, in which its lens barrel unit locates at a front position.

FIG. 6 is a perspective view of the digital camera, shown from its rear side, of FIG. 5, in which its lens barrel unit locates at a side position.

FIG. 7 is a perspective view of the digital camera, shown from its rear side, of FIG. 5, in which its lens barrel unit locates at a rear position.

FIG. 8 is a perspective view of the digital camera, shown from its rear side, of FIG. 5, in which its lens barrel unit locates at a housed position.

FIG. 9 is a perspective view of a digital camera, shown from its front side, according to a third embodiment of the present invention, in which the digital camera is in a state upon taking a still image.

FIG. 10 is a perspective view of the digital camera, shown from its rear side, of FIG. 9, in which the lens barrel unit locates at a position used upon taking a moving image.

FIG. 11 is a perspective view of the digital camera of FIG. 9, showing a state in which the digital camera takes the moving image.

FIG. 12 is an explanatory schematic view of an image taking element employed for the digital camera of FIG. 9.

FIG. 13 is a sectional view of a lens barrel unit of the digital camera of FIG. 1.

FIG. 14 is a sectional view of a lens barrel unit of the digital camera of FIG. 5.

### DETAILED DESCRIPTION OF THE PREFERRED EMBODIMENTS

Before a description of preferred embodiments proceeds, it is to be noted that like or corresponding parts are designated by like reference numerals throughout the accompanying drawings.

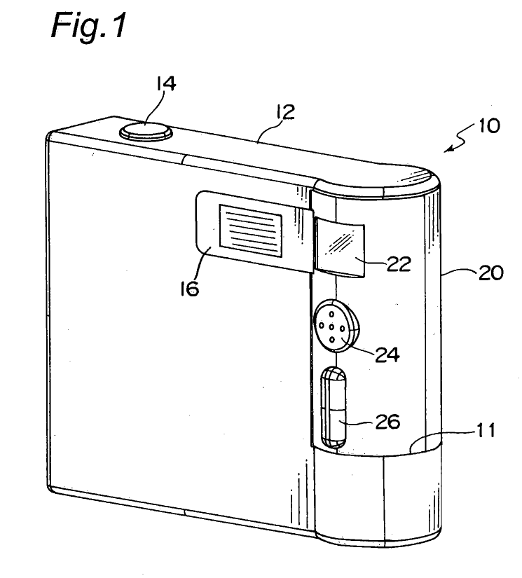

With reference to FIGS. 1 through 14, a description is made below upon a digital camera (hereinafter, also simply referred to as “camera”) according to each of the preferred embodiments thereof.

Firstly, with reference to FIGS. 1 through 4, and FIG. 13, it is explained about the camera 10 according to a first embodiment thereof.

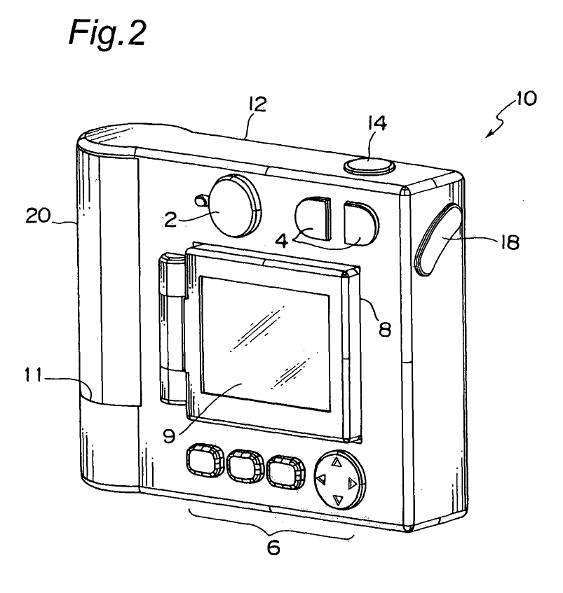

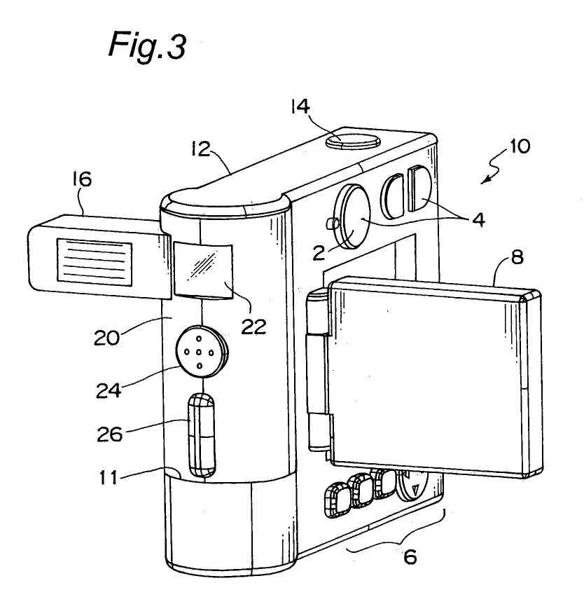

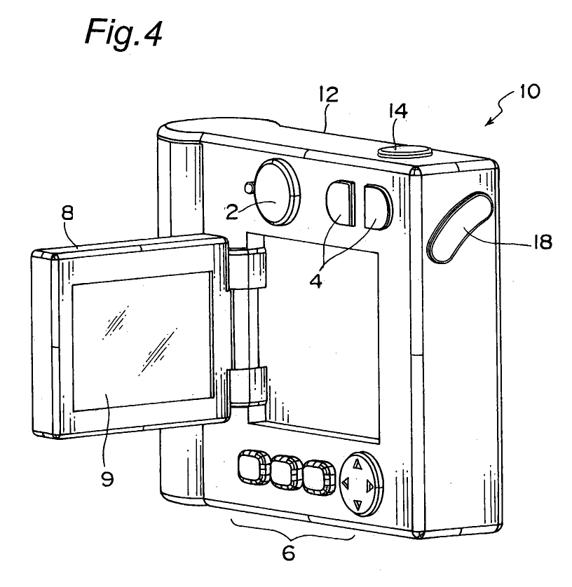

The camera of the first embodiment can take a still image (i.e. still image, or still picture), and can take a moving image (i.e. motion picture, or moving picture), in different modes. That is, each of FIGS. 1 and 2 shows the camera upon taking the still image; on the other hand, each of FIGS. 3 and 4 shows the camera upon taking the moving image. The direction (or image capturing direction) in which a camera body 12 is orientated with respect to an object to be photographed in order to take an image thereof, when the image is a moving image, is different from the direction in which the camera body 12 is orientated with respect to an object to be photographed in order to take an image thereof, when the image is a still image. As shown in FIG. 1 which illustrates the camera 10 upon taking the still image from its front side (i.e. from a side of an object to be photographed), the camera body 12 of the camera 10 is low-profile and generally rectangular (or generally square) in shape. More specifically, each of the front surface and the rear surface (or back surface) of the camera body 12 is the largest of all the surfaces thereof. And, as shown in FIG. 1, the distance between the front surface and the back surface of the camera body 12 is the smallest of all the distances between all the opposing surfaces thereof. Each of the front surface and the back surface of the camera body 12 is generally square in shape.

As shown in FIG. 1, the camera body 12 has a shutter start button 14 (hereinbelow, also simply referred to as “shutter button”) on a side of its top surface. The shutter button 14 is used for giving the instruction to start recording an image like a still image of an object to be photographed and/or a moving image thereof, for example. Meanwhile, the camera body 12 has an opening part 11 which is adjacent to one side thereof (i.e. a right side in FIG. 1), through which a part of the lens barrel unit 20 is exposed outside. In the configuration, the lens barrel unit 20 is arranged in a direction of up and down (i.e. vertically), and the lens barrel unit 20 is pivotally supported inside the camera body 12. The lens barrel unit 20 can be rotated horizontally relative to the camera body 12 manually.

There is provided a flash unit 16 which is fixed to the lens barrel unit 20, in which the flash unit 16 is positioned on a left side of the lens barrel unit 20 in the figure. As shown in FIG. 1, the flash unit 16 is housed in a concave part formed on the front part (i.e. front surface) of the camera body 12, and the front surface of the flash unit 16 forms a part of the front surface of the camera body 12.

There is arranged a lens window 22 on an upper and exposed part of the lens barrel unit 20, a microphone 24 on a central part thereof, and a finger engagement part 26 on a lower part thereof. As shown in FIGS. 1 and 3, when the lens barrel unit 20 is rotated by engaging the user's finger(s) with the finger engagement part 26, the flash unit 16, the lens window 22, the microphone 24, and the finger engagement part 26 are rotated integrally together with the lens barrel unit 20, thus changing, or switching, a direction that the lens window 22 faces, that is, a direction in which the camera takes the image of an object with respect to the camera body 12, namely changing direction of the lens barrel unit 20 relative to a direction in which the camera body 12 is orientated. Hereinafter, the direction in which the lens window 22 faces, is referred to as a “photographing direction”.

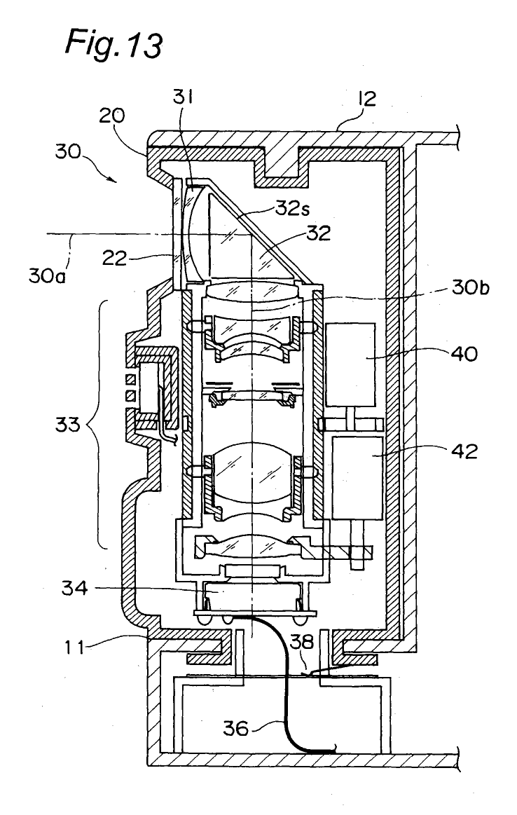

There is mounted an optical system 30 inside the lens barrel unit 20 (see FIG. 13). Namely, there are arranged an objective lens 31 and a triangular prism 32 having a cross section of a right triangle, both behind the lens window 22. The triangular prism 32 has an inclined surface 32s which perpendicularly bends a first optical axis corresponding to a direction in which the camera takes a photograph of an object, downwards in FIG. 13 (i.e. towards a bottom or lower part of the camera body 12). Namely, such an optical system having the function to bend light path, is denominated as a “bent optical system”. On the other hand, along a second optical axis 30b which has been bent by the triangular prism 32, there are arranged lens units 33.

As a modification to the embodiment, instead of the triangular prism 32, it is possible to employ a mirror or a light guide, in order to bend the first optical axis.

Inside the lens barrel unit 20, there are mounted a zoom motor 40 and a focus motor 42 for driving, or moving, a part of the lens units 33. At a location on which the image of an object is focussed, or formed, inside the bent optical system 30, there is arranged a CCD light receiving element 34. Any data signal of image of an object is transmitted from the CCD light receiving element to an unshown electric circuit through a connection wire 36. On a bottom edge part of the lens barrel unit 20, there is mounted a detection switch 38 for detecting a rotational position of the lens barrel unit 20.

When the lens barrel unit 20 rotates, the bent optical system 30, the CCD light receiving element 34, and so on, rotate integrally together with the lens barrel unit 20.

As a modification to the embodiment, the camera can have a construction that allows only a part of the bent optical system 30 (for example, the objective lens 31 and the prism 32) to be rotated integrally together with the lens barrel unit 20.

FIG. 2 shows the digital camera 10 shown from its rear side (i.e. side opposite to an object to be photographed) with the camera 10 being in the mode of taking a still image thereof. As shown in the figure, there is mounted a monitor device 8 on a central rear (or back) side of the camera body 12, a dial lever 2 and a pair of zoom buttons 4 on an upper rear side thereof, and a group of operation buttons 6 on a lower rear side thereof. The dial lever 2 is an operation member for switching its electric power on and off, and for selecting a replay mode, a communication (transmission) mode, etc., and the lever 2 can be rotated by handling its lever part with the user's finger. The zoom button 4 can be used for zooming operation upon taking a still image of an object as explained later. The group of operation buttons 6 is used for switching on and off the monitor device 8, for selecting one of flash modes, for calling a menu, for selecting one of focus areas, and so on. Any real-time image taken by the CCD light receiving element 34, any image having been taken thereby in the past and having been stored on its recording medium, etc. can be displayed on an image plane (or picture plane) 9 of its liquid crystal plane.

As a modification to the embodiment, it is possible to employ a display device other than the liquid crystal panel, such as an EL display device, etc.

As shown in FIG. 2, upon photographing an object, the monitor device 8 is positioned along a rear side (or a back side) of the camera body 12, and the image plane 9 thereof is positioned so as to face outwardly as shown in the figure. One side (i.e. left side in the figure) of the monitor device 8 is supported on the camera body 12 by a biaxial structure (or 2-axis structure). The monitor device 8 can be opened by rotating it through 90° in its horizontal direction, and the image plane 9 of the monitor device 8 can be orientated towards the user (i.e. orientated towards a side opposite to the lens window 22) by rotating it through 180° in its vertical direction, as shown in FIGS. 3 and 4.

By the way, the digital camera 10 has a construction in which a power battery and a recording medium, such as a Compact Flash card (or CF card), for recording data of an object image, can be inserted from a bottom side of the camera body 12.

As shown in FIG. 2, the camera body 12 has a zoom button 18 on a side opposite to the side of the lens barrel unit 20. The zoom button 18 is of a seesaw type of switch, and the zooming operation can be performed by pressing each of ends of the zoom button 18. The zoom button 18 is used for the zooming operation upon taking a moving image (or a motion picture), as described later.

When a still image is taken by the digital camera 10, the image is taken with the flash unit 16 and the monitor device 8 being positioned along the camera body 12, as shown in FIGS. 1 and 2. Namely, when the still image is taken by the camera, generally, the front side (i.e. side of one of a pair of the largest surfaces of all which the camera body 12 has) of the camera body 12 is orientated towards an object the image of which is taken by the digital camera; the camera body 12 is positioned so that the front side, or the front surface, thereof extends generally perpendicular to the photographing direction in which the digital camera captures the image of the object; the user holds both lateral sides, or ends, of the camera body 12 by the hands; and the user operates, or handles, the zoom button 4 on the rear side by the thumb and/or the shutter button 14 on the top side of the camera body 12 by the index finger for photographing the object while he/she is monitoring the image plane 9 on the rear side of the monitor device 8.

On the other hand, when a moving image of an object is taken by the digital camera 10, the moving image is taken with both of the flash unit 16 and the monitor device 8 projecting from the camera body 12, as shown in FIGS. 3 and 4. At this time, the monitor device 8 is positioned relative to the camera body 12 so that the user can easily observe the image plane 9 thereof, after the monitor device 8 has been rotated through 180° in the vertical direction as aforementioned. Namely, when the moving image is taken by the camera, generally, one side (i.e. side of the lens barrel unit 20) of the camera body 12 is made to face the object with the camera body 12 being positioned generally in parallel with the direction in which the camera takes the image of the object; the user operates, or handles, the zoom button 18 on the other side opposite to the lens barrel unit 20 and/or the shutter button 14 on the top side of the camera body 12 while he/she is monitoring the image plane 9 on the monitor device 8 which projects in a direction generally perpendicular to the direction in which the camera take the image thereof. Upon photographing the moving image of an object, it is possible to handle, or manipulate, the camera body 12 by one hand of the user.

More specifically, for example, the camera body 12 can be held in such a manner that the front side (or front surface) and the rear side (or rear surface), each of which has the largest area of all the sides (or surfaces) of the camera body 12, are held or pinched vertically, by the user's thenar eminence and middle finger (also possible to use other fingers of third finger and little finger in addition to the thumb and middle finger); and the zoom button 18 and the shutter button 14 can be manipulated by the thumb and the index finger, respectively.

The camera 10 has a controller which detects the photographing direction in which the lens barrel unit 20 takes an image of an object relative to the camera body 12 by the detection of the detection switch 38, and a proper mode to use is automatically set thereby. That is, as shown in FIGS. 1 and 2, when the photographing direction is generally perpendicular to a direction in which the front surface (or rear surface) of the camera body 12 extends, the controller controls the camera so as to take a still image. On the other hand, as shown in FIGS. 3 and 4, when the photographing direction is generally parallel with the direction in which the front surface (or rear surface) of the camera body 12 extends, the controller controls the camera so as to take a moving image. Also, even if the camera 10 is in the moving image taking mode as shown in FIGS. 3 and 4, it is possible to take a frame of the still image by pressing one of the of operation buttons 6 and the shutter button 14 simultaneously.

According to the mechanism of the first embodiment, the camera has no exterior manual operation member to change modes between the still image taking mode and the moving image taking mode; instead, a suitable mode is automatically selected on the basis of the photographing direction. With the mechanism and function, not only the operability of the camera 10 increases, but also the downsizing of the camera body 12 and a low cost thereof are realized.

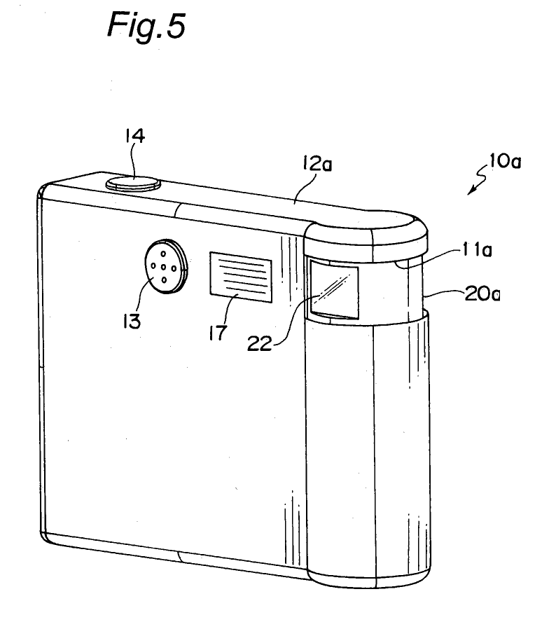

Next, with reference to FIGS. 5 through 8, and FIG. 14, it is explained about the camera 10a according to a second embodiment thereof.

As shown in FIGS. 5 through 8, the camera 10a has a construction (or mechanism) basically similar to that of the camera 10 according to the first embodiment, and the camera 10a can take a still image and a moving image in different modes. Hereinafter, the same reference numeral is used to indicate the part similar or corresponding to that of the camera 10 of the first embodiment, and it is explained about the camera 10a of the second embodiment, mainly focussing any difference in construction in contrast with the camera 10 of the first embodiment.

Similar to the camera body 12 of the digital camera 10 of the first embodiment, the camera body 12a has a low-profile (or thin) and square shape, and the lens barrel unit 20a is rotatably supported at its upper part and at its lower part, respectively, by the camera body 12a.

Different from the first embodiment, the camera body 12a has an opening part 11a on an upper part thereof only, and only the lens window 22 of the lens barrel unit 20a is exposed outside. As shown in FIG. 5, there are mounted a microphone 13 and a flash unit 17 on a front side (or a front surface) of the camera body 12a.

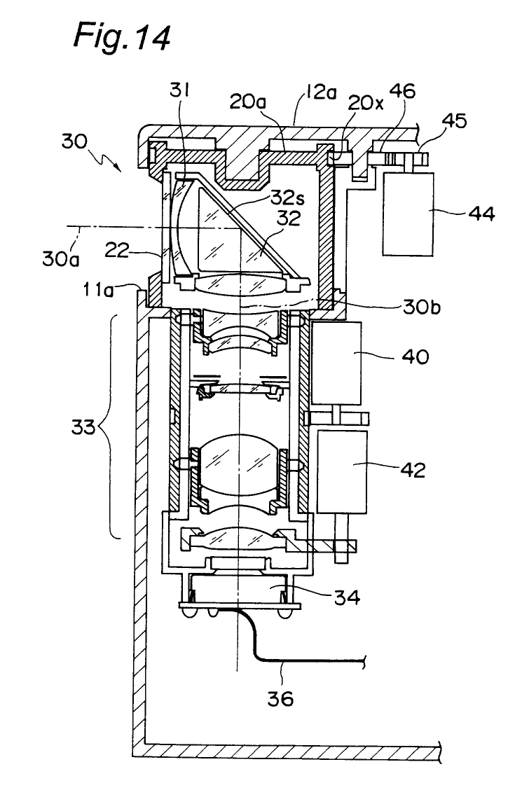

As shown in FIG. 14, similar to the first embodiment, there is mounted a bent optical system 30 inside the lens barrel unit 20a, in which the first optical axis 30a of light from an object is bent generally at 90° into the second optical axis 30b. Different from the first embodiment, however, the lens barrel 20a is driven to rotate by a motor 44. That is, as shown in the figure, the motor 44 has a gear 45 which is fixed to its output shaft, and an upper peripheral part of a housing of the lens barrel unit 20a has gear teeth 20X. These gear 45 of the motor 44 and the gear teeth 20X of the lens barrel unit 20a interlock with each other through an intermediate gear 46.

FIG. 5 shows a front side (or front surface) of the camera body 12a which is in the still image taking position, in which the lens window 22 is in a “front position” where the lens window 22 is orientated ahead or forward (i.e. towards an object) as well as the front side of the camera body 12a. In this position, the first optical axis 30a of the bent optical system 30 is generally perpendicular to the direction in which the front surface of the camera body 12a extends, and the camera 10a can take a still image of an object.

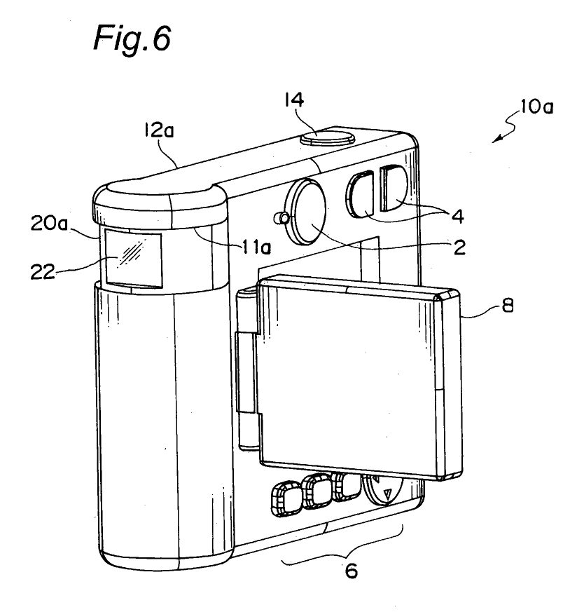

FIG. 6 shows one side or surface, locating between the front side and the rear side, of the camera body 12a which is in the moving image taking position, in which the lens window 22 is in a “side position” where the lens window 22 is orientated ahead or forward (i.e. towards an object) as well as the side or surface of the camera body 12a. In this position, the first optical axis 30a of the bent optical system 30 is generally parallel with the direction in which the front surface, or the rear surface, of the camera body 12a extends, and the camera 10a can take a moving image of an object.

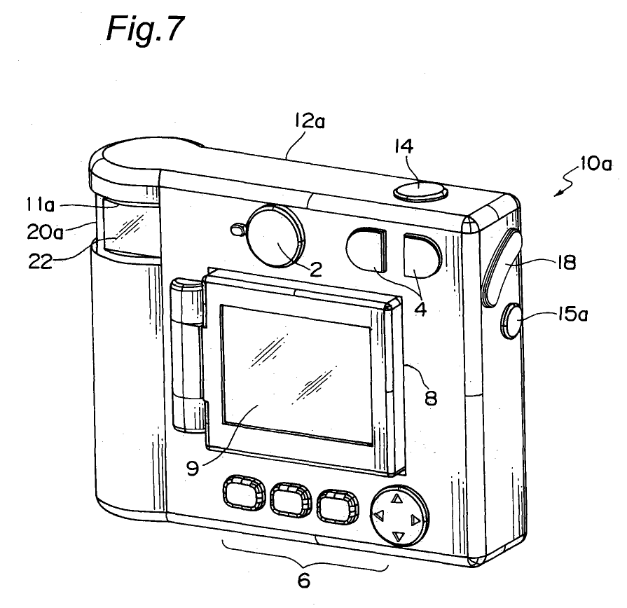

FIG. 7 shows the rear side (or rear surface) of the camera body 12a, and the lens window 22 is in a “rear position” in which the lens window 22 is orientated backwards or rearwards. In this position, the first optical axis 30a of the bent optical system 30 is generally perpendicular to the direction in which the rear surface of the camera body 12a extends, and in this position, it is possible to record sound and/or voice by employing the microphone 13 on the front side of the camera body 12a.

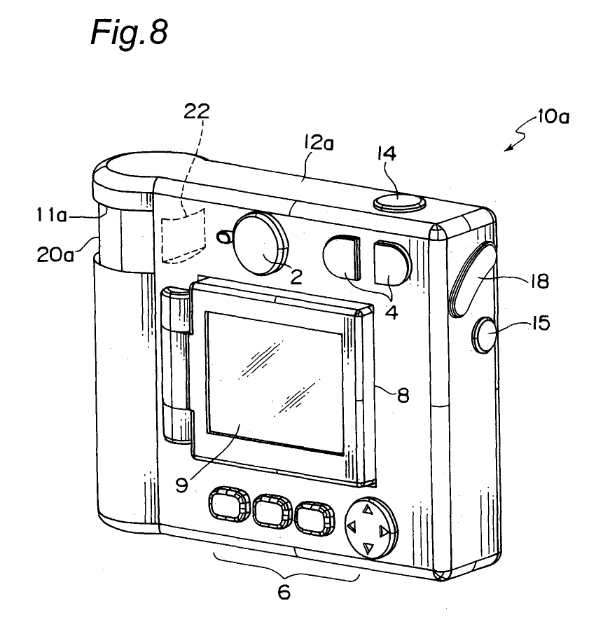

FIG. 8 shows the rear side of the camera body 12a where the lens window 22 is in a “housing position” in which the lens window 22 is housed, or accommodated, inside the camera body 12a (i.e. in which the lens window 22 is hidden inside the camera body 12a). In this position, the first optical axis 30a of the bent optical system 30 is generally parallel with the direction in which the front surface, or the rear surface, of the camera body 12a extends; the first optical axis 30a is directed towards inside of the camera body 12a; and the lens window 22 is hidden inside the camera body 12 so that the lens window 22 is protected. In this housing position of the lens window 22, it is possible to play back (or replay) an image, having been captured, of an object, and to perform various set-up operations (or setting operations).

As shown in the following Table 1 which shows a relation between the dial lever 2 and the lens barrel unit 20a, the digital camera 10a has various modes, and the modes can be set on the basis of location of a dial lever 2 which is mounted on the rear side of the camera body 12a. Depending upon the location of the dial lever 2, the lens barrel unit 20a is automatically driven to rotate.

TABLE 1

| Position of Dial Lever | Position of Lens Barrel Unit |
|---|---|
| OFF | Housing Position |
| Replay Mode | Housing Position |
| Setting Mode | Housing Position |
| Communication Mode | Housing Position |
| Still Image Mode | Front Position |
| Moving Image Mode | Side Position |
| Sound Recording Mode | Rear Position |

When the mode is the “Still Image Mode”, a still image of an object can be taken by the camera 10a. When the mode is the “Moving Image Mode”, a moving image (for example, 30 frames per second) of an object can be taken thereby. When the mode is the “Sound Recording Mode”, only a sound can be recorded thereby.

As a modification to the embodiment, the “Sound Recording Mode” can have an additional voice-memorandum function to record a verbal explanation, for example, about an image having been captured by the camera.

When the mode is the “Replay Mode”, an image having been taken by the camera 10a and having been stored on a memory inside the camera body 12a, is played back or replayed so that the image is displayed on the image plane 9 of the monitor device 8. When the mode is the “Setting Mode”, it is possible to set or change a mode of exposure (for example, program, shutter speed priority, aperture value priority, manual, etc.) and/or to set or change a parameter of recording an image (for example, compression rate of image, size thereof, on/off of white balance, etc.). When the mode is the “Communication Mode”, it is possible to communicate with an external device (for example, a personal computer, a printer, etc.) to transmit and receive data recorded by the camera 10a. As the communication vehicle, it is possible to employ a wire cable, Bluetooth, a wireless LAN, a radio transmission such as mobile phone, etc. When the dial lever 2 is switched off, the operation of the camera 10a is finished.

The various modes switched by the dial lever 2 are arranged as follows. Namely, for example, the position of an “OFF” is arranged at a center in a direction of rotation of the dial lever 2; the “Replay Mode”, “Setting Mode” and “Communication Mode”, each of which is used when the lens barrel unit 20a is not moved, are arranged on one side of the rotation; and the “Still Image Mode”, “Moving Image Mode” and “Sound Recording Mode” are arranged on the other side of the rotation in the order of rotation of the dial lever 2.

Incidentally, the camera 10a can be constructed so that the camera 10a communicates with the external device while the camera 10a is taking a still image or a moving image of an object. In this case, the lens barrel unit 20a is positioned at the front position or at the side position.

By the way, the monitor device 8 has a construction basically similar to that of the camera 10 of the first embodiment, and the angle and orientation thereof can be changed manually.

According to the second embodiment, when the mode is switched over, the photographing direction of the lens barrel unit 20a (therefore, of the bent optical system 30) relative to the camera body 12a is automatically set so as to be fitted, or suitable, for the mode. Therefore, with the mechanism, the operability of the camera 20a increases effectively.

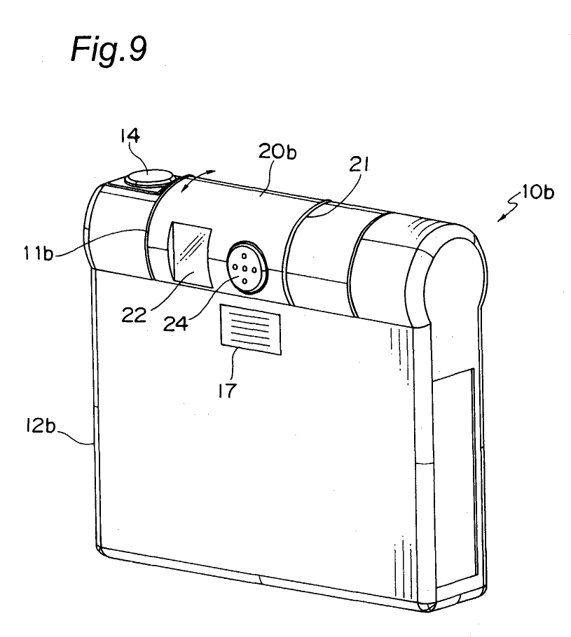

Next, with reference to FIGS. 9 through 12, it is explained about the camera 10b according to a third embodiment thereof.

Hereinafter, the same reference numeral is used to designate the part similar to that of the camera 10, 10a of each of the first and second embodiments. Mainly, focussing a difference in contrast with each of the first and second embodiments, it is explained about the camera according to the third embodiment.

FIG. 9 shows a camera 10b upon taking a still image of an object. Similar to the camera body 12, 12a, of each of the first and second embodiments, the camera body 12b has a thin (or low-profile) square shape. However, different from the camera 10, 10a, of each of the first and second embodiments, the camera body 12b has an opening part 11b on an upper part thereof, and a part of the lens barrel unit 20b is exposed outside through the opening part 11b. As shown in the figure, the lens barrel unit 20b is mounted horizontally relative to the upper part of the camera body 12b, and both ends, in a direction of right and left in the figure, of the lens barrel unit 20b is rotatably supported on the camera body 12b.

Also, different from the first and second embodiments, there is mounted a bent optical system, horizontally, for bending an optical axis generally perpendicularly inside the lens barrel unit 20b so as to focus or form an image of an object.

As shown in FIG. 9, similar to the first embodiment, there are mounted a lens window 22 and a microphone 24 on an exposed part of the lens barrel unit 20b. However, different from the first embodiment, a ring-shaped handling member 21, made of rubber, is mounted on the lens barrel unit 20b. The handling member 21 makes it easy to rotate the lens barrel unit 20b by the hand/finger(s).

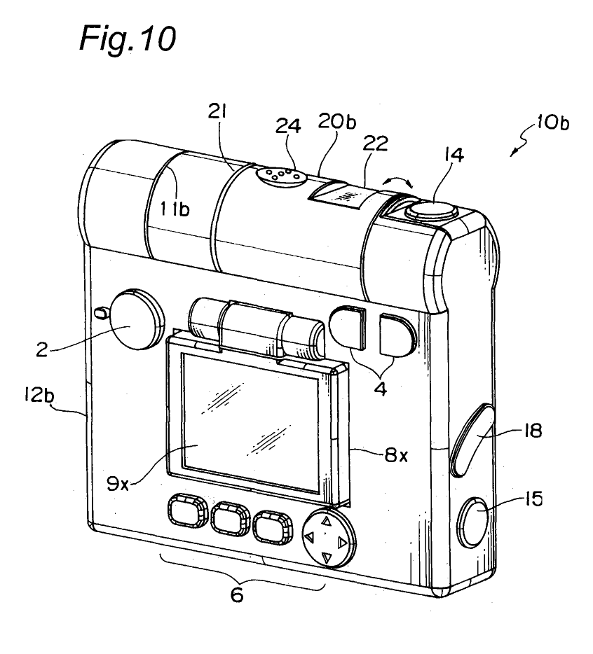

For example, upon taking a still image of an object, both of the lens window 22 and the microphone 24 are orientated, or directed, so as to be on the same side as a front side (or front surface) of the camera body 12b, as shown in FIG. 9. On the other hand, upon taking a moving image of an object, both of the lens window 22 and the microphone 24 are orientated, or directed, upwards, as shown in FIG. 10.

As shown in FIG. 9, the shutter button 14 is mounted on one end (i.e. left end in the figure) of the upper side (or the top side or top surface) of the camera body 12b. Also, as shown in the figure, there is arranged the flash device 17, adjacent to the lens window 22, on the front side (or surface) of the camera body 12b.

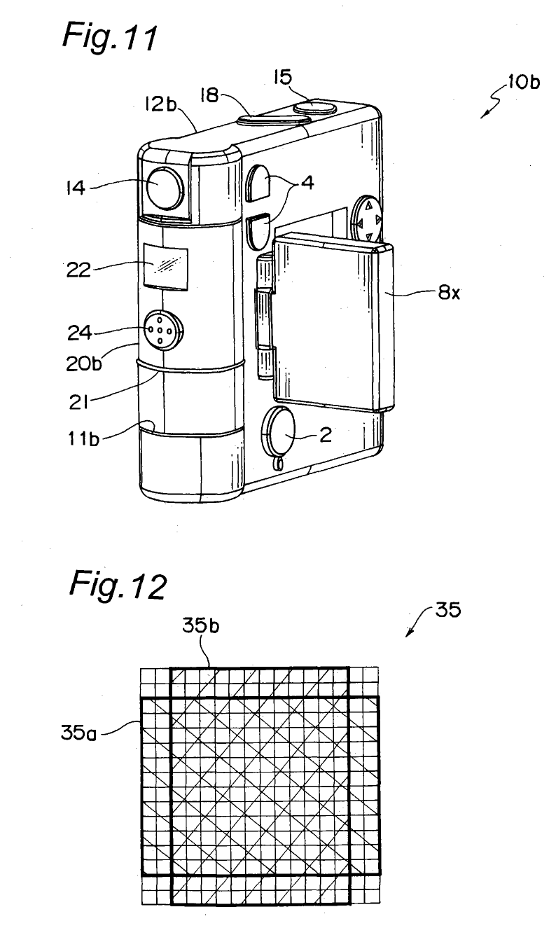

As shown in FIG. 10 which illustrates the camera body 12b from its rear side, there are arranged a dial lever 2 and a zoom button 4, a monitor device 8X having the image plane 9X, and a group of operation switches 6, on the rear side of the camera body 12b, the configuration of which is basically similar to that of each of the first and second embodiments. However, different from the first and second embodiments, the upper part of the monitor device 8X is supported on the camera body 12b by a biaxial construction (or a two-axis construction). With the arrangement, the monitor device 8X can be rotated upwardly in the vertical direction until the surface thereof becomes generally horizontal, and then the monitor device 8X can be twisted through 180° in the vertical direction, thus making the image plane 9X of the monitor device 8X be directed, or orientated, towards the user (i.e. towards the side opposite to the lens window 22) as shown in FIG. 11.

Also, as shown in FIG. 10, there are arranged the shutter button 15 and the zoom button 18 on one side, between the front and rear surfaces, of the camera body 12b.

Upon taking a still image of an object, both of the lateral end parts (i.e. end parts in the direction of right and left in FIGS. 9 and 10) of the camera body 12b are held, or supported, by both hands of the user, and the shutter button 14 on top of the camera body 12b and the zoom button 4 on the rear side thereof are operated manually. Each of the shutter button 14 and the zoom button 4 can operate or function, only when the camera 10b takes a still image of an object.

On the other hand, FIG. 11 shows the camera 10b when it is used for taking a moving image of an object. For taking the moving image, the camera body 12b which is in the posture, as shown in FIGS. 9 and 10, for taking the still image, is turned sideways through 90° so that the both of the shutter button 15 and the zoom button 18 locate on an upside of the camera body 12b. In this posture, the direction in which the surface of each of the lens window 22 and the image plane 9X of the monitor device 8X extends, is generally perpendicular to the direction in which the front surface or rear surface (i.e. one of the largest surfaces of all which the camera body 12b has) of the camera body 12b extends; and the photographing direction of the camera 10b is generally parallel with the direction in which each of the front surface and the rear surface of the camera body 12b extends.

Upon taking a moving image of an object, the user can operate the shutter button 15 and the zoom button 18 arranged on the upper side of the camera body 12b in the posture while he/she holds the camera body 12b by one hand. Each of the shutter button 15 and the zoom button 18 can operate, or function, only when the camera 10b takes a moving image of an object.

As a modification to the embodiment, the camera 10b can be constructed so that the shutter button 15 and the zoom button 18 do not function upon taking a moving image of an object, and so that other function(s) than the operation to start photographing an object and the zooming operation are assigned, or allotted, to the buttons 15 and 18. More specifically, for example, the camera 10b can be constructed so that the mode returns to the still image mode when the shutter button 14 is operated manually at time of the moving image mode. In this case, in the state shown in FIG. 11, the image is a still image, at a vertical format.

According to the configuration of the camera 10b of the third embodiment, the mode for taking the still image or the moving mode is switched over by turning the camera body 12b sideways generally at 90° with the direction in which each of the front surface and the rear surface of the camera body 12b extends remaining in the same direction (i.e. vertical). Therefore, in order to gain an image having a lateral side longer than a vertical side in which the horizontal to vertical ratio is, for example, four to three, a CCD image taking element 35 in which a plurality of pixels are arranged in a form of a square, is employed, as shown in FIG. 12. Namely, upon taking a still image of an object, a first region 35a of the pixels in a form of a rectangle having a lateral side longer than a vertical side is employed. On the other hand, upon taking a moving image of an object, a second region 35b of the pixels in a form of a rectangle having a lateral side shorter than a vertical side is employed.

By the way, in the case that the moving image mode returns to the still image mode by operating the shutter button 14 as aforementioned, the second region 35b of the pixels is switched over into the first region 35a thereof, and the still image at the vertical format.

As aforementioned, the camera 10b of the third embodiment is turned sideways in order to change over between the photo-taking of the still image and that of the moving image. In the mechanism, the operation members 14, 4, 15, 18 can be arranged on the camera body 12b at positions suitable for facilitating the hold by the user's hand(s) and/or finger(s) relative to the camera body 12b, and thereby the operativity of the camera is enhanced.

As aforementioned, each of the cameras 10, 10a and 10b according to the first, second and third embodiments, has a high operativity, not only upon capturing a still image of an object, but also upon capturing a moving image thereof.

Although the present invention has been fully described in connection with the preferred embodiments thereof with reference to the accompanying drawings, it is to be noted that various other changes and modifications are apparent to those skilled in the art.

For example, as a modification, the camera can be constructed so that an image taking part can be removably attached to the camera body, and the photographing direction can be changed by changing the direction in which the image taking part is attached to the camera body. In the construction, the direction in which the image taking part is attached to the camera body can be detected, and the direction in which the optical system takes the image can be changed on the basis of the detection.

Also, as a modification, the camera can be constructed so that the power switch of the camera can be switched off when the direction in which the optical system takes the image of an object becomes the direction in which the optical system is protected.

Also, as a modification, the camera can have at least one attachment member which can change a location for attaching a strap used for holding the camera body by the hand(s)/finger(s), depending upon the photographing direction. For example, when the photographing direction corresponds to the direction perpendicular to the direction in which the front surface (or the rear surface) of the camera body extends, the at least one attachment member can be mounted on a lateral side of the camera body; on the other hand, when the photographing direction corresponds to the direction parallel to the direction in which the front surface (or the rear surface) of the camera body extends, the at least one attachment member can be mounted on a front side of the camera body.

Such changes and modifications are also to be understood as included within the scope of the present invention as defined by the appended claims unless they depart therefrom. order to take an image thereof, when the image is a still image, and its user takes a photograph of the object with his/her holding the camera body by the hand in both of the situations.

Meanwhile, there has been provided a camera which can change its direction in which the image of an object is captured or taken. For example, there has been provided a camera that its angle for photographing an object can be changed, by shifting the angle of the liquid crystal viewfinder (display part) and by shifting the photographing unit, as disclosed in Japanese Laid-Open Patent Publication No. 10-285440. Also, for example, there has been provided a camera that lenses and a light emitter of a flash device rotate up and down integrally so as to facilitate the capture of the object image at a low angle and at a high angle, respectively, and that the self-image is possible to be taken, as disclosed in U.S. Pat. No. 6,445,417 B1.

Meanwhile, there has been proposed a portable terminal (PDA or Personal Digital Assistant) having a camera that its function can be switched over by changing the angle between its monitor and the body of the portable terminal. Namely, the portable terminal can be used as a camera when the monitor is opened; on the other hand, it can be used as a portable terminal when the monitor is

What is claimed is:

1. A digital camera comprising:
an optical system which can change a direction of taking an image of an object with respect to a body of the digital camera;
an operation part for switching a mode between a first mode and a second mode; and
a mechanism for making the optical system change the direction of taking the image thereof, in interlock with a switchover of the mode therebetween by the operation part.

2. The digital camera as claimed in claim 1, wherein the direction of taking the image of the object is changed by a rotation of a lens barrel which has the optical system.

3. The digital camera as claimed in claim 2, wherein the optical system is a bent optical system, and
wherein the lens barrel is rotated about an optical axis which has been bent.

4. The digital camera as claimed in claim 1, wherein the mode is selected from one of:
an image taking mode in which the first mode corresponds to a still image taking mode and in which the second mode corresponds to a moving image taking mode,
a sound recording mode in which the first mode corresponds to an ON mode and in which the second mode corresponds to an OFF mode,
a playback mode in which the first mode corresponds to an ON mode and in which the second mode corresponds to an OFF mode, and
a communication mode in which the first mode corresponds to an ON mode and in which the second mode corresponds to an OFF mode.

5. The digital camera as claimed in claim 1, which further comprises a viewfinder which can change a direction in which the viewfinder shows the image of the object relative to the body of the digital camera.

6. The digital camera as claimed in claim 1, which further comprises:
a housing which has a low-profile and square shape; and
a lens barrel, the direction of taking the image thereof by the lens barrel being able to be switched into one of a first direction corresponding to a shortest side of the housing and a second direction perpendicular to the first direction,
wherein the mode is a selective mode,
wherein the selective mode is at least an image taking mode, in which the first mode corresponds to a still image taking mode and in which the second mode corresponds to a moving image taking mode, and
wherein when the direction of taking the image by the lens barrel is switched into the first direction corresponding to the shortest side of the housing, the still image taking mode is selected, and when the direction of taking the image thereby is switched into the second direction perpendicular to the first direction, the moving image taking mode is selected.

7. The digital camera as claimed in claim 6, wherein there is provided a first operation member on one side of the housing, in which the first operation member is used for taking a still image of the object, and wherein there is provided at least one second operation member on another side of the housing, in which the at least one second operation member is used for taking a moving image of the object.

8. The digital camera as claimed in claim 7, wherein the second operation member is one of a shutter button and a zoom button.

9. A digital camera comprising:
an optical system which can change a direction of taking an image of an object with respect to a body of the digital camera; and
a detector for detecting a change of the direction of taking the image thereof,
wherein the digital camera has a selective mode including a first mode and a second mode, in which one of the first mode and the second mode is selected on a basis of the change of the direction thereof detected by the detector.

10. The digital camera as claimed in claim 9, wherein the direction of taking the image of the object is changed by a rotation of a lens barrel which has the optical system.

11. The digital camera as claimed in claim 10, wherein the optical system is a bent optical system, and
wherein the lens barrel is rotated about an optical axis which has been bent.

12. The digital camera as claimed in 9, wherein the selective mode is selected from one of:
an image taking mode in which the first mode corresponds to a still image taking mode and in which the second mode corresponds to a moving image taking mode,
a sound recording mode in which the first mode corresponds to an ON mode and in which the second mode corresponds to an OFF mode,
a playback mode in which the first mode corresponds to an ON mode and in which the second mode corresponds to an OFF mode, and
a communication mode in which the first mode corresponds to an ON mode and in which the second mode corresponds to an OFF mode.

13. The digital camera as claimed in claim 9, which further comprises a viewfinder which can change a direction in which the viewfinder shows the image of the object relating to the body of the digital camera.

14. The digital camera as claimed in claim 9, which further comprises:
a housing which has a low-profile and square shape; and
a lens barrel, the direction of taking the image thereof by the lens barrel being able to be switched into one of a first direction corresponding to a shortest side of the housing and a second direction perpendicular to the first direction,
wherein the selective mode is at least an image taking mode, in which the first mode corresponds to a still image taking mode and in which the second mode corresponds to a moving image taking mode, and
wherein when the direction of taking the image by the lens barrel is switched into the first direction corresponding to the shortest side of the housing, the still image taking mode is selected, and when the direction of taking the image thereby is switched into the second direction perpendicular to the first direction, the moving image taking mode is selected.

15. The digital camera as claimed in claim 14, wherein there is provided a first operation member on one side of the housing, in which the first operation member is used for taking a still image of the object, and wherein there is provided at least one second operation member on another side of the housing, in which the at least one second operation member is used for taking a moving image of the object.

16. The digital camera as claimed in claim 15, wherein the second operation member is one of a shutter button and a zoom button.

17. A digital camera comprising:
an optical system, a direction of taking an image of an object by the optical system being able to be changed about an axis which is parallel to a direction in which a longer side of an upper surface of a housing of the digital camera extends, in which the digital camera has a first image taking mode and a second image taking mode;
a first operation member which functions when the digital camera is in the first image taking mode;
a second operation member which functions when the digital camera is in the second image taking mode; and
a controller for switching an enable/disable of function of the first operation member and the second operation member, on a basis of the direction of taking the image of the object.

18. The digital camera as claimed in claim 17, wherein the first operation member is mounted on the upper surface of the housing, and the second operation member is mounted on a side surface of the housing.

19. The digital camera as claimed in claim 17, wherein the first image taking mode is a still image taking mode, and the second image taking mode is a moving image taking mode.

20. The digital camera as claimed in claim 17, which further comprises a viewfinder which can change a direction in which the viewfinder shows the image of the object relative to the housing of the digital camera.
